(19) United States
(12) Patent Application Publication
(10) Pub. No.: US 2019/0236954 A1
(43) Pub. Date: Aug. 1, 2019

(54) PARKING AREA DETECTION DEVICE

(71) Applicant: AISIN SEIKI KABUSHIKI KAISHA, Kariya-shi (JP)

(72) Inventors: Naoya KOMURA, Kariya-shi (JP); Masashi FUJIWARA, Okazaki-shi (JP)

(73) Assignee: AISIN SEIKI KABUSHIKI KAISHA, Kariya-shi (JP)

(21) Appl. No.: 16/262,114

(22) Filed: Jan. 30, 2019

(30) Foreign Application Priority Data
Jan. 31, 2018 (JP) 2018-015144

(51) Int. Cl. G08G 1/14; G05D 1/02

(52) U.S. Cl. CPC G08G 1/149; G05D 1/021; G08G 1/146

(57) ABSTRACT

A parking area detection device includes: a storage unit configured to store therein own vehicle information indicating a type of an own vehicle; a detection unit configured to detect a parking area around the own vehicle and parking area information indicating a type of a vehicle that is allowed to park in the parking area based on a captured image obtained by imagining a periphery of the own vehicle using an imaging unit; and a determination unit configured to determine whether or not the own vehicle information matches the parking area information and cause a display unit to display a determination result.

### CROSS REFERENCE TO RELATED APPLICATIONS

This application is based on and claims priority under 35 U.S.C. § 119 to Japanese Patent Application 2018-015144, filed on Jan. 31, 2018, the entire contents of which are incorporated herein by reference.

### TECHNICAL FIELD

Embodiments of this disclosure relate to a parking area detection device.

### BACKGROUND DISCUSSION

A technology has been proposed in which the parking area of a vehicle is searched for based on the necessity of charging the vehicle via transmission and reception of the necessity of charging the vehicle between a parking management device on the parking lot side and a terminal device on the vehicle side. See, for example, JP2014-031104A (Reference 1), JP2016-134061A (Reference 2), and JP2016-124398A (Reference 3).

However, the technology in which the parking area of the vehicle is searched for based on the necessity of charging the vehicle lacks versatility since the parking area of only a specific vehicle that requires charging as a target is searched for and no parking area may be searched for with respect to a vehicle other than the specific vehicle. In addition, since it is necessary to perform communication between the parking management device and the terminal device, there occurs a need to introduce a system that enables the retrieval of the parking area of a vehicle with respect to both the parking lot side and the vehicle side.

### SUMMARY

As an example, a parking area detection device according to an embodiment includes a storage unit configured to store therein own vehicle information indicating a type of an own vehicle, a detection unit configured to detect a parking area around the own vehicle and parking area information indicating a type of a vehicle that is allowed to park in the parking area based on a captured image obtained by imagining a periphery of the own vehicle using an imaging unit, and a determination unit configured to determine whether or not the own vehicle information matches the parking area information and cause a display unit to display a determination result.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating an example of a state where a portion of a vehicle compartment of a vehicle on which a parking area detection device according to the present embodiment is mounted is seen through;

FIG. 2 is a plan view of an example of the vehicle according to the present embodiment;

FIG. 3 is a block diagram illustrating an example of a functional configuration of the vehicle according to the present embodiment;

FIG. 4 is a block diagram illustrating an example of a functional configuration of an ECU provided in the vehicle according to the present embodiment;

FIG. 5 is a flowchart illustrating an example of the flow of a parking area search processing in the vehicle according to the present embodiment;

FIG. 6 is a view illustrating an example of a parking assistance screen in the vehicle according to the present embodiment; and

FIG. 7 is a view illustrating an example of the parking assistance screen in the vehicle according to the present embodiment.

### DETAILED DESCRIPTION

Hereinafter, an exemplary embodiment disclosed here will be described. A configuration of the embodiment illustrated below and actions, results, and effects caused by the configuration are given by way of example. This disclosure may be realized by a configuration other than the configuration disclosed in the following embodiment, and at least one of various effects based on the basic configuration or derivative effects may be obtained.

A vehicle on which a parking area detection device according to the present embodiment is mounted may be a vehicle (internal combustion engine vehicle) that uses an internal combustion engine (engine) as a drive source, a vehicle (e.g., an electric vehicle or a fuel cell vehicle) that uses an electric motor (motor) as a drive source, or a vehicle (hybrid vehicle) that uses both the internal combustion engine and the electric motor as a drive source. In addition, the vehicle may be equipped with any of various transmission devices and various other devices (e.g., systems and components) required for driving the internal combustion engine or the electric motor. In addition, for example, the type, the number, and the layout of the device related to the driving of wheels in the vehicle may be set in various ways.

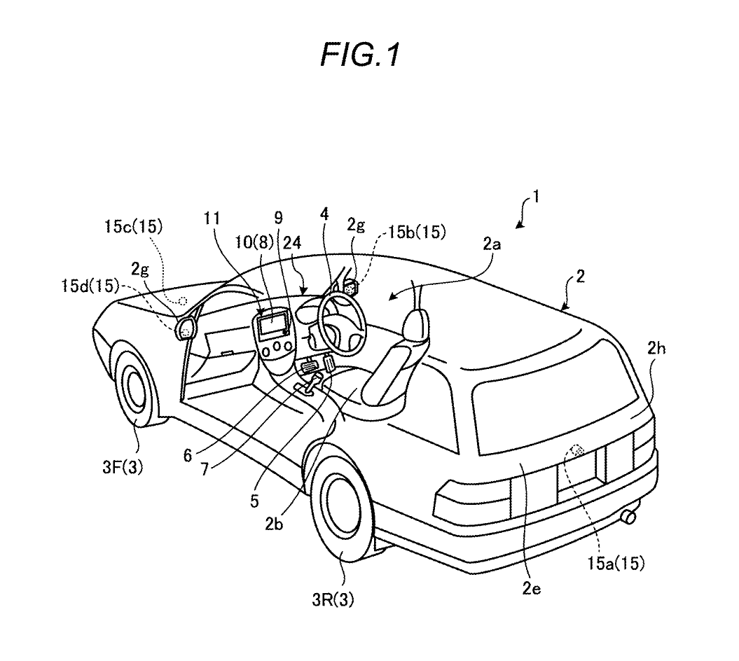

FIG. 1 is a perspective view illustrating an example of a state where a portion of the vehicle compartment of a vehicle on which a parking area detection device according to the present embodiment is mounted is seen through. As illustrated in FIG. 1, the vehicle 1 includes a vehicle body 2, a steering unit 4, an acceleration operation unit 5, a braking operation unit 6, a speed change operation unit 7, and a monitor device 11. The vehicle body 2 has a vehicle compartment 2a in which an occupant rides. Inside the vehicle compartment 2a, for example, the steering unit 4, the acceleration operation unit 5, the braking operation unit 6, and the speed change operation unit 7 are provided in a state where a driver as the occupant rides on a seat 2b. The steering unit 4 is, for example, a steering wheel which protrudes from a dashboard 24. The acceleration operation unit 5 is, for example, an accelerator pedal which is positioned under the driver's feet. The braking operation unit 6 is, for example, a brake pedal which is positioned under the driver's feet. The speed change operation unit 7 is, for example, a shift lever which protrudes from a center console.

The monitor device 11 is provided, for example, on the central portion of the dashboard 24 in the vehicle width direction (i.e., the transverse direction). For example, the monitor device 11 may have a function such as, for example, a navigation system or an audio system. The monitor device 11 includes a display device 8, a voice output device 9, and an operation input unit 10. In addition, the monitor device 11 may include various operation input units such as, for example, a switch, a dial, a joystick, and a push button.

The display device 8 is configured with a liquid crystal display (LCD) or an organic electroluminescent display (OELD), and is capable of displaying various images based on image data. The voice output device 9 is configured with, for example, a speaker and outputs various voices based on voice data. The voice output device 9 may be provided at a position different from the monitor device 11 in the vehicle compartment 2a.

The operation input unit 10 is configured with, for example, a touch pane and enables the input of various pieces of information by the occupant. In addition, the operation input unit 10 is provided on a display screen of the display device 8, and is capable of transmitting an image displayed on the display device 8. Therefore, the operation input unit 10 allows the occupant to view the image displayed on the display screen of the display device 8. The operation input unit 10 receives an input of various pieces of information by the occupant by detecting a touch operation of the occupant on the display screen of the display device 8.

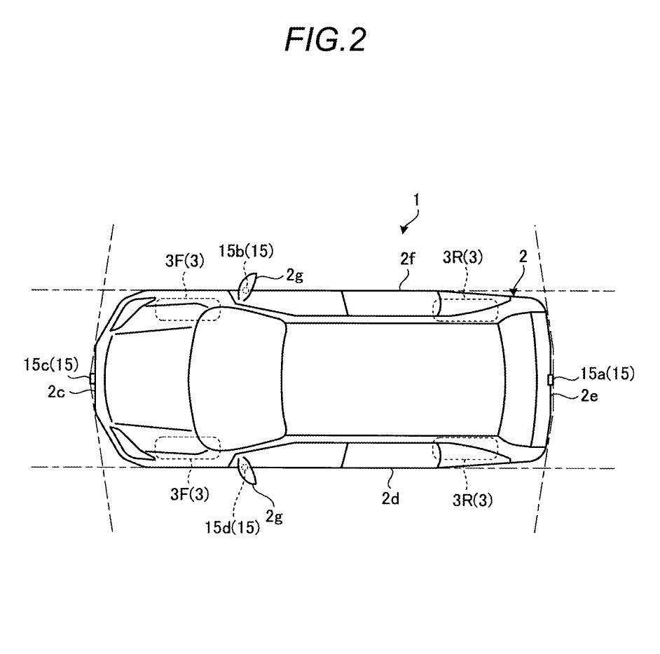

FIG. 2 is a plan view of an example of the vehicle according to the present embodiment. As illustrated in FIGS. 1 and 2, the vehicle 1 is, for example, a four-wheeled automobile and includes two left and right front wheels 3F and two left and right rear wheels 3R. All or some of the four wheels 3 may be steered.

The vehicle 1 is equipped with a plurality of imaging units 15. In the present embodiment, for example, the vehicle 1 is equipped with four imaging units 15a to 15d. The imaging units 15 are digital cameras each having an imaging device such as, for example, a charge coupled device (CCD) or a CMOS image sensor (CIS). The imaging units 15 are capable of imaging the periphery of the vehicle 1 at a predetermined frame rate. Then, the imaging units 15 output captured images obtained by imaging the periphery of the vehicle 1. Each of the imaging units 15 includes a wide angle lens or a fisheye lens, and is capable of imaging the range from 140° to 220°, for example, in the horizontal direction. In addition, the optical axes of the imaging units 15 may be set obliquely downward in some cases.

Specifically, for example, the imaging unit 15a is located on a rear end 2e of the vehicle body 2 and is provided on a wall portion under a rear window of a rear hatch door 2h. Then, the imaging unit 15a is capable of imaging the area behind the vehicle 1 in the periphery of the vehicle 1. For example, the imaging unit 15b is located on a right end 2f of the vehicle body 2 and is provided on a right door mirror 2g. Then, the imaging unit 15b is capable of imaging the area on the lateral side of the vehicle 1 in the periphery of the vehicle 1. For example, the imaging unit 15c is located on the front side of the vehicle body 2, i.e., on a front end 2c in the longitudinal direction of the vehicle 1 and is provided on a front bumper or a front grill. Then, the imaging unit 15c is capable of imaging the area in front of the vehicle 1 in the periphery of the vehicle 1. For example, the imaging unit 15d is located on the left side of the vehicle body 2, i.e., on a left end 2d in the vehicle width direction and is provided on a left door mirror 2g. Then, the imaging unit 15d is capable of imaging the area on the lateral side of the vehicle 1 in the periphery of the vehicle 1.

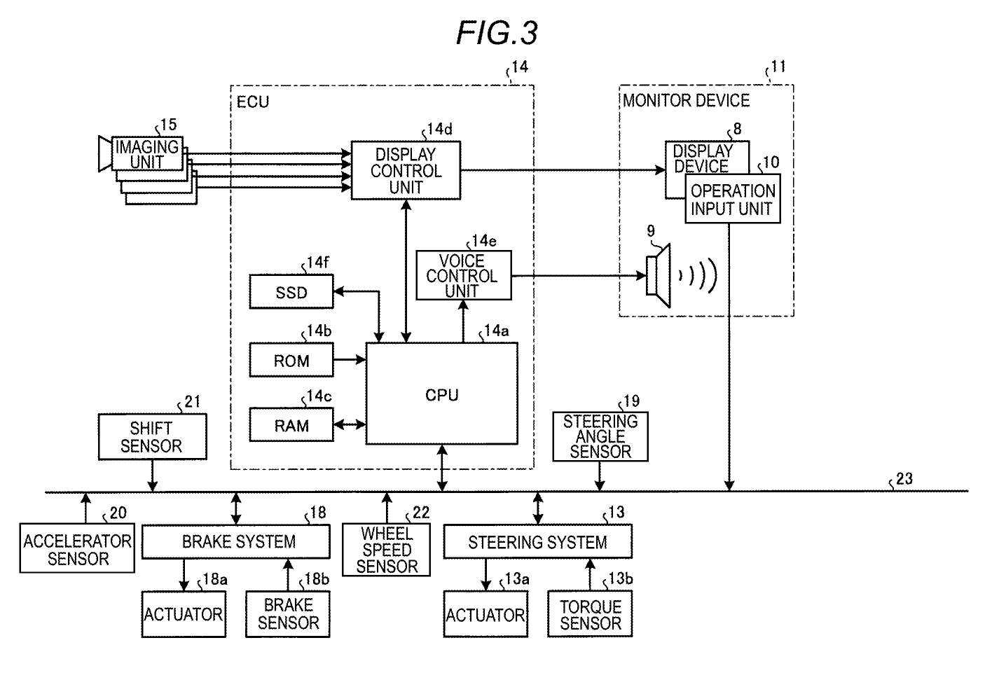

FIG. 3 is a block diagram illustrating an example of a functional configuration of the vehicle according to the present embodiment. As illustrated in FIG. 3, the vehicle 1 includes a steering system 13, a brake system 18, a steering angle sensor 19, an accelerator sensor 20, a shift sensor 21, a wheel speed sensor 22, an in-vehicle network 23, and an electronic control unit (ECU) 14. The monitor device 11, the steering system 13, the brake system 18, the steering angle sensor 19, the accelerator sensor 20, the shift sensor 21, the wheel speed sensor 22, and the ECU 14 are electrically connected to each other via the in-vehicle network 23 which is an electric communication line. The in-vehicle network 23 is configured with a controller area network (CAN) or the like.

The steering system 13 is an electric power steering system or a steer by wire (SBW) system. The steering system 13 includes an actuator 13a and a torque sensor 13b. Then, the steering system 13 is electrically controlled by the ECU 14, and operates the actuator 13a to apply a torque to the steering unit 4 so as to compensate for a steering force, thereby steering the wheels 3. The torque sensor 13b detects the torque that the driver gives to the steering unit 4, and transmits the detection result to the ECU 14.

The brake system 18 includes an anti-lock brake system (ABS) that controls the locking of a brake of the vehicle 1, an electronic stability control (ESC) that suppresses the side slip of the vehicle 1 at the time of cornering, an electric brake system that increases a brake force to assist the brake, and a brake by wire (BBW). The brake system 18 includes an actuator 18a and a brake sensor 18b. The brake system 18 is electrically controlled by the ECU 14, for example, to apply a braking force to the wheels 3 via the actuator 18a. The brake system 18 detects, for example, the locking of the brake, the idling of the wheels 3, and the sign of side slip from a difference in the rotation of the right and left wheels 3, for example, to control the locking of the brake, the idling of the wheels 3, and the side slip. The brake sensor 18b is a displacement sensor that detects the position of the brake pedal as a movable element of the braking operation unit 6, and transmits the detection result of the position of the brake pedal to the ECU 14.

The steering angle sensor 19 is a sensor that detects the amount of steering of the steering unit 4 such as, for example, a steering wheel. In the present embodiment, the steering angle sensor 19 is configured with, for example, a Hall element, and detects the rotation angle of a rotating element of the steering unit 4 as the amount of steering and transmits the detection result to the ECU 14. The accelerator sensor 20 is a displacement sensor that detects the position of an accelerator pedal as a movable element of the acceleration operation unit 5, and transmits the detection result to the ECU 14.

The shift sensor 21 is a sensor that detects the position of a movable element (e.g., a bar, an arm, or a button) of the speed change operation unit 7, and transmits the detection result to the ECU 14. The wheel speed sensor 22 is a sensor that includes, for example, a Hall element, and detects the amount of rotation of the wheels 3 or the number of revolutions per minute of the wheels 3, and transmits the detection result to the ECU 14.

The ECU 14 executes a parking area search processing of detecting a parking space that is an area where the vehicle 1 can be parked based on captured images obtained by imaging the periphery of the vehicle 1 using the imaging units 15. The ECU 14 is configured with, for example, a computer and controls the entire vehicle 1 in cooperation with hardware and software. Specifically, the ECU 14 includes a central processing unit (CPU) 14a, a read only memory (ROM) 14b, a random access memory (RAM) 14c, a display control unit 14d, a voice control unit 14e, and a solid state drive (SSD) 14f. The CPU 14a, the ROM 14b, and the RAM 14c may be provided in the same circuit board.

The CPU 14a reads out a program stored in a nonvolatile storage device such as, for example, the ROM 14b and executes various arithmetic processings according to the program. For example, the CPU 14a executes, for example, an image processing on image data to be displayed on the display device 8 and calculation of the distance to an obstacle which exists around the vehicle 1.

The ROM 14b stores, for example, various programs and parameters necessary for executing the programs. The RAM 14c temporarily stores various data used for the calculation in the CPU 14a. The display control unit 14d mainly executes, for example, an image processing on image data which is acquired from the imaging units 15 and is output to the CPU 14a and conversion from the image data acquired from the CPU 14a to image data to be displayed on the display device 8, among the arithmetic processings in the ECU 14. The voice control unit 14e mainly executes a processing of voice which is acquired from the CPU 14a and is output to the voice output device 9, among the arithmetic processings in the ECU 14. The SSD 14f is a rewritable nonvolatile storage unit, and continues to store data acquired from the CPU 14a even when a power supply of the ECU 14 is turned off.

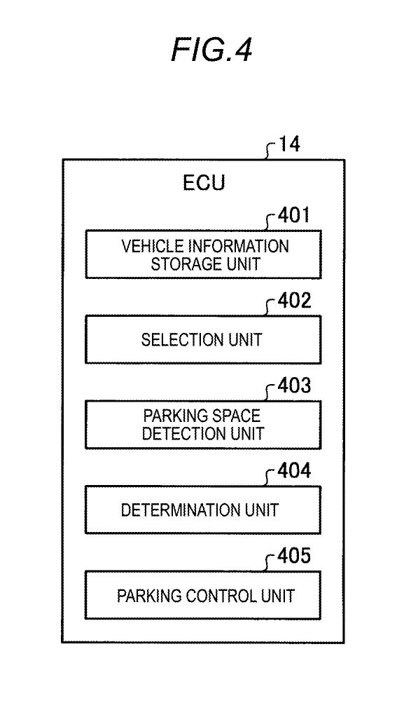

FIG. 4 is a block diagram illustrating an example of a functional configuration of the ECU provided in the vehicle according to the present embodiment. As illustrated in FIG. 4, the ECU 14 includes a vehicle information storage unit 401, a selection unit 402, a parking space detection unit 403, a determination unit 404, and a parking control unit 405. For example, a processor such as, for example, the CPU 14a mounted on the circuit board may execute a parking space detection program stored in a storage medium such as, for example, the ROM 14b or the SSD 14f, so that the ECU 14 realizes functions of the selection unit 402, the parking space detection unit 403, the determination unit 404, and the parking control unit 405. Some or all of the selection unit 402, the parking space detection unit 403, the determination unit 404, and the parking control unit 405 may be configured with hardware such as, for example, a circuit.

The vehicle information storage unit 401 is configured with, for example, the SSD 14f, and is a storage unit that stores own vehicle information indicating the type of the vehicle 1 (e.g., an internal combustion engine vehicle, an electric vehicle, a fuel cell vehicle, or a welfare vehicle). The selection unit 402 selects own vehicle information according to an operation of the operation input unit 10 (operation unit) by the occupant (user) of the vehicle 1. Then, the selection unit 402 stores the own vehicle information selected by the user in the vehicle information storage unit 401.

The parking space detection unit 403 acquires the captured images obtained by imaging the periphery of the vehicle 1 using the imaging units 15. Then, the parking space detection unit 403 detects a parking space around the vehicle 1 and parking area information indicating the type of a vehicle that is allowed to park in the parking space based on the acquired captured images.

The determination unit 404 compares the own vehicle information stored in the vehicle information storage unit 401 with the detected parking area information and determines whether or not the own vehicle information matches the parking area information. Then, the determination unit 404 controls the display control unit 14d to display, on the display device 8, the determination result as to whether or not the own vehicle information matches the parking area information.

In this way, since it is possible to determine whether or not the vehicle 1 can be parked even with respect to the parking space of the vehicle 1 other than a specific type of vehicle (e.g., an electric vehicle), the versatility of the parking area detection device may be enhanced. In addition, since it is possible to search for the parking space in which the vehicle 1 can be parked by introducing the parking area detection device to only the vehicle 1 side, the parking space in which the vehicle 1 can be parked may be searched for without introducing a new system to the parking lot side. In addition, it is possible to reduce the cost required for realizing a system that searches for the parking space of the vehicle 1. In addition, since it is possible to notify the driver of whether or not the vehicle 1 can be parked with respect to the parking space, it is possible to prevent the vehicle 1 which does not require a dedicated parking space such as, for example, the parking space for a welfare vehicle from being parked in the dedicated parking space.

The parking control unit 405 controls, for example, the steering system 13 or the brake system 18 to execute parking assistance control of automatically parking the vehicle 1 with respect to a parking area having parking area information matching the own vehicle information. Therefore, it is possible to prevent the vehicle 1 from being erroneously parked with respect to a parking space in which the vehicle 1 cannot be parked.

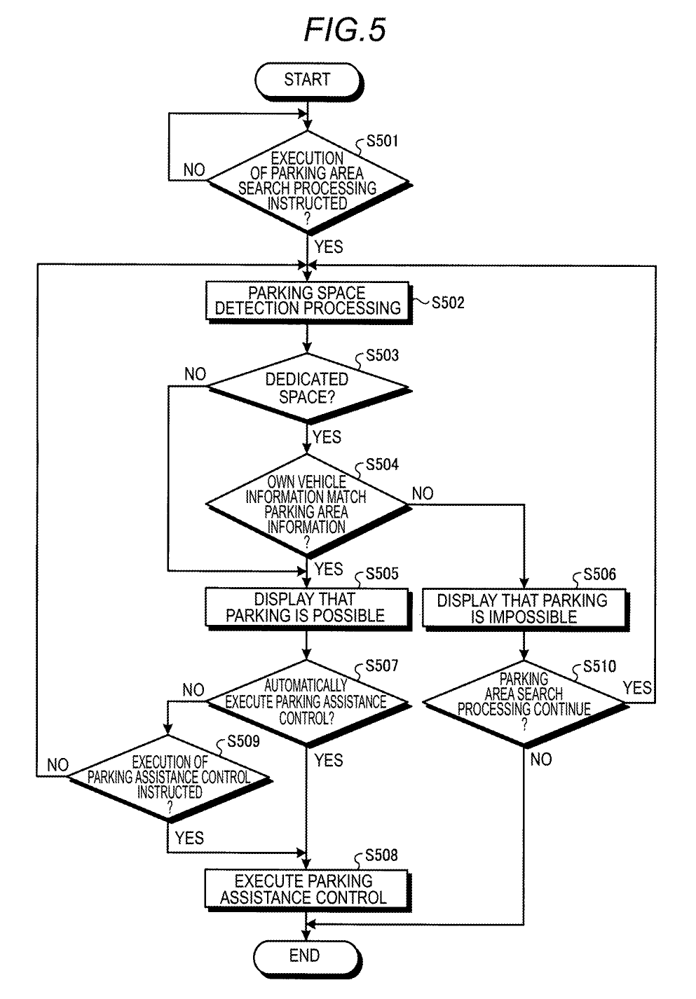

FIG. 5 is a flowchart illustrating an example of the flow of a parking area search processing in the vehicle according to the present embodiment. In the present embodiment, it is assumed that the selection unit 402 stores the own vehicle information input by the operation of the operation input unit 10 in the vehicle information storage unit 401 in advance. Therefore, it is possible to prevent the vehicle 1 which does not require a dedicated parking space from being parked in the dedicated parking space.

In addition, in the present embodiment, when the type of the vehicle 1 is an electric vehicle or a fuel cell vehicle, the selection unit 402 adds, to the own vehicle information, setting information as to whether or not to change the determination result as to whether or not the own vehicle information matches the parking area information according to the charge amount of the electric vehicle or the remaining amount of fuel of the fuel cell vehicle. In addition, in the present embodiment, the selection unit 402 sets whether or not to perform the parking area search processing (On or Off of the parking area search processing) in advance according to the operation of the operation input unit 10. When the parking area search processing is turned off, a processing to be described below is not performed. Therefore, it is possible to expand the parking area search processing by executing the parking area search processing so as to suit to the driver's preference of the vehicle 1.

The parking space detection unit 403 determines whether or not the operation input unit 10 such as, for example, a button displayed on the display device 8 or a hardware switch provided in advance in the vehicle 1 is operated so that the execution of the parking area search processing is instructed (step S501). In the present embodiment, the parking space detection unit 403 determines whether or not the execution of the parking area search processing has been instructed according to the operation of the operation input unit 10, but the disclosure is not limited thereto.

For example, when the position of the vehicle 1 detected using, for example, a global positioning system (GPS) receiver is within a parking lot or in the vicinity of the parking lot in map information, the parking space detection unit 403 may determine that the execution of the parking space search processing has been instructed. Alternatively, the parking space detection unit 403 may detect the vehicle speed of the vehicle 1 based on the detection result of the number of revolutions of the wheels 3 by the wheel speed sensor 22, and may determine that the execution of the parking space search processing has been instructed when the detected vehicle speed is equal to or less than a predetermined vehicle speed. Here, the predetermined vehicle speed is a preset vehicle speed, and is, for example, a vehicle speed of 10 km/h or less at which the vehicle 1 slowly moves. Alternatively, the parking space detection unit 403 may determine whether or not the execution of the parking area search processing is instructed using both the map information and the vehicle speed of the vehicle 1. Specifically, when the position of the vehicle 1 detected using, for example, the GPS receiver is within or in the vicinity of the parking lot in the map information and when the vehicle speed of the vehicle 1 is equal to or less than the predetermined vehicle speed, the parking space detection unit 403 determines that the execution of the parking area search processing has been instructed.

When the execution of the parking area search processing is instructed (step S501: Yes), the parking space detection unit 403 acquires captured images obtained by imaging the periphery of the vehicle 1 using the imaging units 15, and based on the captured images, executes a parking space detection processing of detecting a parking space around the vehicle 1 (step S502). In the present embodiment, the parking space detection unit 403 acquires captured images from the imaging units 15b and 15d which are capable of imaging the lateral side of the vehicle 1. In addition, in the present embodiment, the parking space detection unit 403 detects a parking space using information indicating the boundary of a parking space such as, for example, a white line included in the acquired captured images.

Subsequently, the parking space detection unit 403 determines whether or not the detected parking space is a dedicated parking space (hereinafter referred to as a dedicated space) for which the type of the vehicle 1 that can be parked is limited (step S503). In the present embodiment, the parking space detection unit 403 extracts feature information such as, for example, letters or symbols such as, for example, “light” or “EV” displayed in the detected parking space, a charging device existing in the vicinity of the parking space, and the color of the parking space. Then, the parking space detection unit 403 compares the extracted feature information with predetermined feature information, and determines whether or not the detected parking space is a dedicated space. Here, the predetermined feature information is preset feature information, and is feature information on the dedicated space and the vicinity thereof.

Then, when the extracted feature information matches the predetermined feature information or when the similarity between the extracted feature information and the predetermined feature information is equal to or higher than preset similarity, the parking space detection unit 403 determines that the detected parking space is a dedicated space. On the other hand, when the similarity between the extracted feature information and the predetermined feature information is lower than the predetermined similarity, the parking space detection unit 403 determines that the detected parking space is a general parking space which is a parking space in which any type of vehicle can be parked.

In addition, when it is determined that the detected parking space is a dedicated space, the parking space detection unit 403 detects parking area information which is the type of a vehicle that can be parked in the detected dedicated space. For example, when the letters displayed in the detected parking space are “light”, the parking space detection unit 403 detects parking area information indicating a small car. In addition, when the letters displayed in the detected parking space are “EV” or when a charging device is present in the vicinity of the detected parking space, the parking space detection unit 403 detects parking area information indicating an electric vehicle.

Subsequently, when it is determined that the detected parking space is a dedicated space (step S503: Yes), the determination unit 404 determines whether or not the own vehicle information stored in the vehicle information storage unit 401 matches the detected parking area information, i.e., whether or not the type of the vehicle 1 matches the type of a vehicle that can be parked in the dedicated space (step S504). When the type of the vehicle 1 matches the type of the vehicle that can be parked in the dedicated space (step S504: Yes) or when the detected parking space is a parking space (hereinafter referred to as a general parking space) other than a dedicated space (S503: No), the determination unit 404 controls the display control unit 14d to cause the display device 8 to display that the vehicle 1 can be parked in the detected parking space (step S505). On the other hand, when the type of the vehicle 1 does not match the type of the vehicle that can be parked in the dedicated space (step S504: No), the determination unit 404 causes the display device 8 to display that the vehicle 1 cannot be parked in the detected parking space (step S506).

When the display device 8 displays that the vehicle 1 can be parked with respect to the detected parking space, the parking control unit 405 determines whether or not to automatically execute parking assistance control (step S507). In the present embodiment, the occupant such as, for example, the driver of the vehicle 1 may operate the operation input unit 10 to set in advance whether or not to automatically execute the parking assistance control when the parking space is detected. When the automatic execution of the parking assistance control is set (step S507: Yes), the parking control unit 405 automatically starts the parking assistance control for the detected parking space (step S508).

On the other hand, when the automatic execution of the parking assistance control is not set (step S507: No), the parking control unit 405 determines whether or not the execution of the parking assistance control is instructed by the operation of the operation input unit 10 (step S509). When the execution of the parking assistance control is instructed (step S509: Yes), the parking control unit 405 executes the parking assistance control for the detected parking space (step S508). On the other hand, when the execution of the parking assistance control is not instructed (step S509: No), the parking control unit 405 determines that the parking area search processing is to be continued, and returns to step S502 to execute the parking space detection processing again. Alternatively, the parking control unit 405 may sequentially determine whether or not to continue the parking area search processing according to the operation of the operation input unit 10 whenever it is determined that the execution of the parking assistance control is not instructed. Alternatively, the parking control unit 405 may determine to continue the parking area search processing unless the operation input unit 10 instructs to stop the parking area search processing or unless the vehicle 1 leaves the parking lot.

In addition, when the display device 8 displays that the vehicle 1 cannot be parked in the detected parking space (step S506), the parking control unit 405 determines whether or not to continue the parking area search processing (step S510). In the present embodiment, the parking control unit 405 sequentially determines whether or not to continue the parking area search processing according to the operation of the operation input unit 10 whenever the display device 8 displays that the vehicle 1 cannot be parked in the parking space. Alternatively, the parking control unit 405 may determine to continue the parking area search processing unless the operation input unit 10 instructs to stop the parking area search processing or unless the vehicle 1 leaves the parking lot. When it is determined that the parking area searching process is to be continued (step S510: Yes), the parking control unit 405 returns to step S502 to execute the parking space detection processing. On the other hand, when it is determined that the parking area search processing is not to be continued (step S510: No), the parking area search processing is terminated.

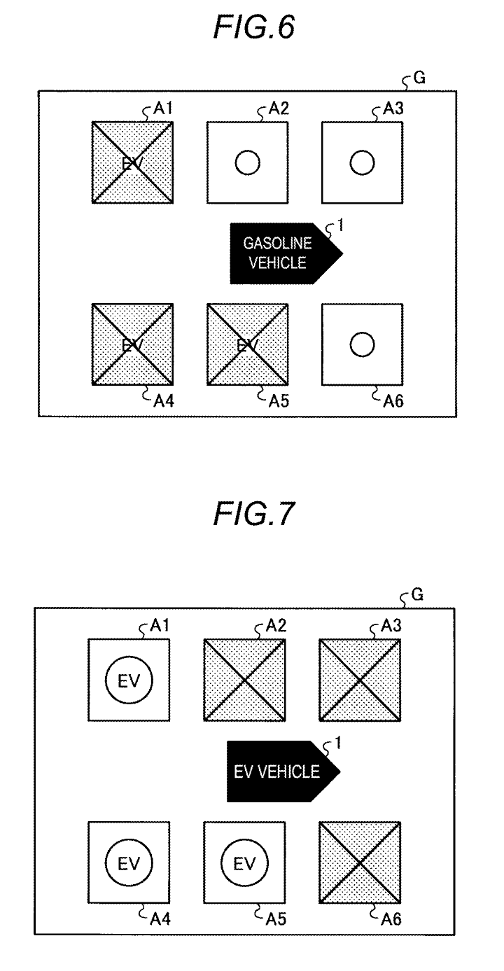

FIGS. 6 and 7 are views illustrating an example of a parking assistance screen in the vehicle according to the present embodiment. In the present embodiment, the determination unit 404 causes the display device 8 to display a parking assistance screen that makes it possible to identify whether or not the vehicle 1 can be parked with respect to the detected parking space as the determination result as to whether or not the own vehicle information matches the parking area information. Since this makes it easy to identify whether or not the vehicle 1 can be parked with respect to the detected parking space, it is possible to effectively prevent the vehicle 1 from being erroneously parked with respect to a parking space in which the vehicle 1 cannot be parked.

For example, as illustrated in FIG. 6, when the type of the vehicle 1 is an internal combustion engine vehicle (e.g., a gasoline vehicle) and six parking spaces A1 to A6 are detected, the determination unit 404 causes the display device 8 to display a parking assistance screen G including the detected parking spaces A1 to A6 and the vehicle 1. In addition, the determination unit 404 causes the display device 8 to display information indicating that parking is possible (e.g., “O”) with respect to the parking spaces A2, A3 and A6 (general parking spaces) in which the vehicle 1 can be parked, among the parking spaces A1 to A6. In addition, the determination unit 404 causes the display device 8 to display information indicating that parking is impossible (e.g., “x”) with respect to the parking spaces A1, A4, and A5 (parking spaces for an electric vehicle) in which the vehicle 1 cannot be parked, among the parking spaces A1 to A6.

On the other hand, as illustrated in FIG. 7, when the type of the vehicle 1 is an electric vehicle (so-called EV vehicle) and six parking spaces A1 to A6 are detected, the determination unit 404 causes the display device 8 to display the parking assistance screen G including the detected parking spaces A1 to A6 and the vehicle 1. In addition, the determination unit 404 causes the display device 8 to display information indicating that parking is possible (e.g., “O”) with respect to the parking spaces A1, A4 and A5 in which the vehicle 1 can be parked, among the parking spaces A1 to A6. In addition, the determination unit 404 causes the display device 8 to display information indicating that parking is impossible (e.g., “x”) with respect to the parking spaces A2, A3 and A6 in which the vehicle 1 cannot be parked, among the parking spaces A1 to A6.

In addition, when the type of the vehicle 1 indicated by the own vehicle information is an electric vehicle or a fuel cell vehicle, the determination unit 404 may change the determination result as to whether or not the own vehicle information matches the parking area information according to whether or not the charge amount of the vehicle 1 or the remaining amount of fuel is equal to or greater than a predetermined amount. Here, the predetermined amount is a preset charge amount or a preset remaining amount of fuel, and for example, is 80% or more of the charge amount or the remaining amount of fuel on the basis of the upper limit of the charge amount or the remaining amount of fuel of the vehicle 1. For example, when the type of vehicle 1 is an electric vehicle and the charge amount of the vehicle 1 is equal to or greater than the predetermined amount, the determination unit 404 expands the parking space in which the vehicle 1 can be parked to a general parking space. In this case, the determination unit 404 causes the display device 8 to display information indicating that parking is possible (e.g., “O”) with respect to all of the parking spaces A1 to A6 illustrated in FIG. 7. Since this makes it possible to guide the electric vehicle or the fuel cell vehicle to the general parking space, it is possible to expand the selection range of the parking space of the electric vehicle or the fuel cell vehicle.

When the parking assistance screen G is displayed on the display device 8, the occupant of the vehicle 1 may select the parking space in which the vehicle 1 is to be parked by performing a touch operation on the parking space in which information indicating that parking is possible is displayed, among the parking spaces A1 to A6 displayed on the parking assistance screen G. Then, when the touch operation on the parking space by the operation input unit 10 is detected, the parking control unit 405 executes parking assistance control for the selected parking space.

In addition, when the selected parking space (e.g., the parking space A1) is a parking space in which the direction in which the vehicle 1 is parked is set (e.g., a parking space for forward parking), the determination unit 404 causes the display device 8 to display a selection screen that allows selection of the direction (forward or rearward) in which the vehicle 1 is parked before the parking assistance control for the parking space A1 is executed after a touch operation on the parking space A1 is detected. Whether or not the parking space A1 is the parking space in which the direction in which the vehicle 1 is parked is set is detected by the parking space detection unit 403 based on the captured images obtained by the imaging using the imaging units 15b and 15d. For example, when the letters (e.g., “forward parking”) indicating that the parking space is a parking space for forward parking are detected behind the parking space included in the captured images, the parking space detection unit 403 determines that the detected parking space is a parking space for forward parking. Then, the parking control unit 405 executes the parking assistance control so that the vehicle 1 is parked according to the direction selected on the selection screen. Thus, the vehicle 1 may be parked in the parking space according to the direction desired by the driver of the vehicle 1.

In addition, the own vehicle information including the direction (e.g., forward or rearward) in which the vehicle 1 is parked may be stored in the vehicle information storage unit 401. In this case, the determination unit 404 changes the determination result as to whether or not the own vehicle information matches the parking area information according to the direction included in the own vehicle information. For example, when the direction of the vehicle 1 that can be parked in the parking space detected by the parking space detection unit 403 matches the direction included in the own vehicle information, the determination unit 404 maintains the detected parking space as the parking space in which the vehicle 1 can be parked. On the other hand, when the direction of the vehicle 1 that can be parked in the parking space detected by the parking space detection unit 403 does not match the direction included in the own vehicle information, the determination unit 404 excludes the detected parking space from the parking space in which the vehicle 1 can be parked. Thus, the vehicle 1 may be parked with respect to the parking space in which the vehicle can be parked in the direction desired by the driver of the vehicle 1.

As described above, according to the vehicle 1 of the present embodiment, since it is possible to determine whether or not the vehicle 1 can be parked even with respect to parking spaces of various kinds of vehicles, the versatility of the parking area detection device may be enhanced. In addition, since it is possible to search for the parking space in which the vehicle 1 can be parked by introducing the parking area detection device into only the vehicle 1, the parking space in which the vehicle 1 can be parked may be searched for without introducing a new system to the parking lot side.

As an example, a parking area detection device according to an embodiment includes a storage unit configured to store therein own vehicle information indicating a type of an own vehicle, a detection unit configured to detect a parking area around the own vehicle and parking area information indicating a type of a vehicle that is allowed to park in the parking area based on a captured image obtained by imagining a periphery of the own vehicle using an imaging unit, and a determination unit configured to determine whether or not the own vehicle information matches the parking area information and cause a display unit to display a determination result. Thus, as an example, since it is possible to determine whether or not a vehicle can be parked even with respect to the parking area of the vehicle other than a specific type of vehicle, the versatility of the parking area detection device may be enhanced.

In addition, as another example, in the parking area detection device according to the embodiment, the determination unit causes the display unit to display, as the determination result, a screen that enables identification of whether or not the own vehicle is allowed to park in the parking area. Thus, as an example, it is possible to effectively prevent a vehicle from being erroneously parked with respect to a parking space in which the vehicle cannot be parked.

In addition, as another example, the parking area detection device according to the embodiment further includes a selection unit configured to select the own vehicle information and store the information in the storage unit according to an operation of an operation unit by a user. Thus, as an example, it is possible to prevent a vehicle that does not require a dedicated parking area from being parked in the dedicated parking space.

In addition, as another example, in the parking area detection device according to the embodiment, the determination unit changes the determination result according to whether or not a charge amount of the own vehicle or a remaining amount of fuel is equal to or greater than a predetermined amount when a type of the own vehicle indicated by the own vehicle information is an electric vehicle or a fuel cell vehicle. Thus, as an example, it is possible to expand the selection range of the parking space of an electric vehicle or a fuel cell vehicle.

In addition, as another example, the parking area detection device according to the embodiment further includes a parking control unit configured to automatically park the own vehicle with respect to the parking area corresponding the parking area information that matches the own vehicle information. Thus, as an example, it is possible to prevent a vehicle from being erroneously parked with respect to a parking area in which the vehicle cannot be parked.

In addition, as another example, the parking area detection device according to the embodiment, the determination unit causes the display unit to display the determination result according to whether or not a charge amount of the own vehicle or a remaining amount of fuel is equal to or greater than a predetermined amount when a type of the own vehicle indicated by the own vehicle information is an electric vehicle or a fuel cell vehicle.

In addition, as another example, the parking area detection device according to the embodiment, the selection unit stores, in the storage unit, whether or not to detect the parking area information according to the operation of the operation unit by the user.

In addition, as another example, the parking area detection device according to the embodiment, the selection unit stores, in the storage unit, whether or not to detect the parking area information according to a position of the own vehicle.

In addition, as another example, the parking area detection device according to the embodiment, the selection unit stores, in the storage unit, whether or not to detect the parking area information according to a speed of the own vehicle.

In addition, as another example, the parking area detection device according to the embodiment, the selection unit stores, in the storage unit, whether or not to detect the parking area information according to a position of the own vehicle and a speed of the own vehicle.

In addition, as another example, the parking area detection device according to the embodiment, the parking area information is at least one of a letter indicating the type of the own vehicle, a symbol indicating the type of the own vehicle, a charging device, and a color of the parking area

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A parking area detection device comprising:
a storage unit configured to store therein own vehicle information indicating a type of an own vehicle;
a detection unit configured to detect a parking area around the own vehicle and parking area information indicating a type of a vehicle that is allowed to park in the parking area based on a captured image obtained by imagining a periphery of the own vehicle using an imaging unit; and
a determination unit configured to determine whether or not the own vehicle information matches the parking area information and cause a display unit to display a determination result.

2. The parking area detection device according to claim 1,
wherein the determination unit causes the display unit to display, as the determination result, a screen that enables identification of whether or not the own vehicle is allowed to park in the parking area.

3. The parking area detection device according to claim 1, further comprising:
a selection unit configured to select the own vehicle information and store the information in the storage unit according to an operation of an operation unit by a user.

4. The parking area detection device according to claim 1,
wherein the determination unit changes the determination result according to whether or not a charge amount of the own vehicle or a remaining amount of fuel is equal to or greater than a predetermined amount when a type of the own vehicle indicated by the own vehicle information is an electric vehicle or a fuel cell vehicle.

5. The parking area detection device according to claim 1, further comprising:
a parking control unit configured to automatically park the own vehicle with respect to the parking area corresponding to the parking area information that matches the own vehicle information.

6. The parking area detection device according to claim 1,
wherein the determination unit causes the display unit to display the determination result according to whether or not a charge amount of the own vehicle or a remaining amount of fuel is equal to or greater than a predetermined amount when a type of the own vehicle indicated by the own vehicle information is an electric vehicle or a fuel cell vehicle.

7. The parking area detection device according to claim 3,
wherein the selection unit stores, in the storage unit, whether or not to detect the parking area information according to the operation of the operation unit by the user.

8. The parking area detection device according to claim 3,
wherein the selection unit stores, in the storage unit, whether or not to detect the parking area information according to a position of the own vehicle.

9. The parking area detection device according to claim 3,
wherein the selection unit stores, in the storage unit, whether or not to detect the parking area information according to a speed of the own vehicle.

10. The parking area detection device according to claim 3,
wherein the selection unit stores, in the storage unit, whether or not to detect the parking area information according to a position of the own vehicle and a speed of the own vehicle.

11. The parking area detection device according to claim 1,
wherein the parking area information is at least one of a letter indicating the type of the own vehicle, a symbol indicating the type of the own vehicle, a charging device, and a color of the parking area.
